(19) United States
(12) Patent Application Publication
(10) Pub. No.: US 2010/0244607 A1
(43) Pub. Date: Sep. 30, 2010

(54) ROTOR OF ROTARY ELECTRIC MACHINE AND METHOD OF MANUFACTURING THE SAME

(75) Inventors: Kengo FUJIMOTO, Chiyoda-ku (JP); Yoshihito Asao, Chiyoda-ku (JP); Satoru Akutsu, Chiyoda-ku (JP); Kazuhisa Takashima, Chiyoda-ku (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Tokyo (JP)

(21) Appl. No.: 12/541,711

(22) Filed: Aug. 14, 2009

(30) Foreign Application Priority Data
Mar. 31, 2009 (JP) 2009-085983

(51) Int. Cl. H02K 1/28; H02K 15/03

(52) U.S. Cl. 310/156.21; 29/598; 310/156.31

(57) ABSTRACT

In a rotor of a permanent magnet rotary electric machine, a bonding portion between each of segment shaped magnets and an outer circumference face of a rotor core is provided in axial symmetry with respect to the rotor axial center and has a bonding area equal to or larger than a half of a contact area between each of the segment shaped magnets and the outer circumference face of the rotor core; and a biasing force is applied to an outer circumference face of the segment shaped magnets by a ring.

### BACKGROUND OF THE INVENTION

1. Field of the Invention

The present invention relates to rotors of rotary electric machines and, more particularly, relates to a structure of a rotor of a permanent magnet rotary electric machine and a method of manufacturing the same.

2. Description of the Related Art

As known rotors of rotary electric machines, there is known one in which an adhesive is formed on shaft end faces and/or circumferential end faces of permanent magnets in order to prevent a crack in the magnets in the case of magnetization of the permanent magnets.
(For example, see Japanese Unexamined Patent Publication No. 2005-65388)

In the case of magnetization of permanent magnets and during product operation, a large external force is exerted on the magnets; however, if bonding strength of segment shaped magnets and a rotor core is biased in an axial direction, it is likely to fracture because a large moment is exerted on the magnets. In addition, if a bonding state is bad, it causes that peel-off of the magnets from the rotor core occurs and a large moment is exerted on the magnets in the case of the magnetization and during the product operation as in the above mention.

In one disclosed in Japanese Unexamined Patent Publication No. 2005-65388, an adhesive is formed on shaft end faces and/or circumferential end faces of the permanent magnets in order to prevent a crack in the permanent magnets in the case of magnetization of the permanent magnets. However, the adhesive is formed on only the shaft end faces and/or circumferential end faces of the permanent magnets; and therefore, there is a case that it is not possible to obtain sufficient bonding strength. Further, as a result, the bonding strength is largely influenced by application accuracy of the adhesive.

However, configuration and idea, which improve the bonding strength itself, are not disclosed in Japanese Unexamined Patent Publication No. 2005-65388.

### BRIEF SUMMARY OF THE INVENTION

The present invention has been made to solve the foregoing problem, and an object of the present invention is to obtain a high reliability rotor of a rotary electric machine and a method of manufacturing the same, both of which can easily ensure stable magnet retention strength and bonding strength.

According to the present invention, there is provided a rotor of a rotary electric machine, the rotary electric machine including: a rotor core fitted to an outer circumference of a rotational shaft; a rotor formed by arranging and bonding a plurality of segment shaped magnets each having an arbitrary gap between poles on an outer circumference portion of the rotor core by adhesive; a bracket rotatably supporting a rotational shaft of the rotor via bearings; and a stator fixed to the bracket and having a stator core and stator windings. The rotor of the rotary electric machine includes: a bonding portion formed by the adhesive between each of the segment shaped magnets of the rotor and the outer circumference face of the rotor core, the bonding portion being provided in axial symmetry with respect to the rotor axial center and having a bonding area equal to or larger than a half of a contact area between each of the segment shaped magnets and the outer circumference face of the rotor core; and a nonmagnetic ring fitted to an outer circumference portion of the segment shaped magnets, the segment shaped magnets being fixed by being biased by the ring to the rotor core side.

Further, in a method of manufacturing the rotor of the rotary electric machine, the segment shaped magnets are bonded from a radial direction of the rotor core.

Still further, in a method of manufacturing the rotor of the rotary electric machine, the ring is press-fitted to the outer circumference portion of the segment shaped magnets.

Yet still further, in a method of manufacturing the rotor of the rotary electric machine, the ring is shrink-fitted to the outer circumference portion of the segment shaped magnets.

According to the present invention, there can be obtained a high reliability rotor of a rotary electric machine and a method of manufacturing the same, both of which can prevent from occurring a moment like fracturing magnets, the moment being caused by sufficient bonding strength and even an external force due to magnetization and the like; further, suppress magnet inclination and a foaming phenomenon during hardening adhesive, caused by a radial biasing force due to a ring.

The foregoing and other object, features, and advantages of the present invention will become more apparent from the following detailed description of preferred embodiments and description shown in drawings.

### BRIEF DESCRIPTION OF THE SEVERAL VIEWS OF THE DRAWING

FIGS. 1A to 1C show a rotor of a rotary electric machine of Preferred Embodiment 1 of the present invention, FIG. 1A is a sectional view showing an example applicable to a motor for an electric power steering apparatus, FIG. 1B is a view showing only the rotor shown in FIG. 1A, and FIG. 1C is a view showing a bonded state between a rotor core and each of magnets of the rotor;

FIG. 2 is a view showing a relationship between a circumscribed circle diameter of an outer circumference of respective magnets and a ring inner diameter of a rotor in Preferred Embodiment 2 of the present invention;

FIG. 3 is a view showing a shape of a ring attached to an outer diameter of rotor magnets in Preferred Embodiment 3 of the present invention;

FIGS. 4A to 4C show a rotor of a rotary electric machine of Preferred Embodiment 4 of the present invention, FIG. 4A is a view showing an example of a shape of a ring attached to an outer diameter of rotor magnets, FIG. 4B is a view showing other example of a shape of a ring attached to an outer diameter of rotor magnets, and FIG. 4C is a view showing further other example of a shape of a ring attached to an outer diameter of rotor magnets;

FIGS. 5A to 5C show a rotor of a rotary electric machine in Preferred Embodiment 5 of the present invention, FIG. 5A is a view showing an example of a side shape of a rotor core to which rotor magnets are stuck, FIG. 5B is a view showing other example of a side shape of a rotor core to which rotor magnets are stuck, and FIG. 5C is a view showing further other example of a side shape of a rotor core to which rotor magnets are stuck;

FIG. 6 is a view showing a relationship between the axial lengths of a rotor core and each of magnets of a rotor in Preferred Embodiment 6 of the present invention;

FIG. 7 is a view showing a state of an adhesive formed between a rotor core and each of magnets of a rotor in Preferred Embodiment 7 of the present invention;

FIG. 8 is a view showing surface finishing of rotor magnets in Preferred Embodiment 8 of the present invention;

FIGS. 9A and 9B show a rotor of a rotary electric machine of Preferred Embodiment 9 of the present invention, FIG. 9A is a view showing a structure of a rotor core of a rotor, and FIG. 9B is a typical view showing a state between an adhesive and the rotor core;

FIG. 10 is a view showing a manufacturing method related to bonding of rotor magnets in Preferred Embodiment 10 of the present invention;

FIG. 11 is a view for explaining a manufacturing method related to assembling of a rotor ring in Preferred Embodiment 11 of the present invention; and

FIG. 12 is a view for explaining a manufacturing method related to assembling of a rotor ring in Preferred Embodiment 12 of the present invention.

### DETAILED DESCRIPTION OF THE INVENTION

Preferred embodiments of the present invention will be described below in detail with reference to the drawings. Incidentally, the same reference numerals as those shown in the respective drawings represent the same or corresponding elements.

### Preferred Embodiment 1

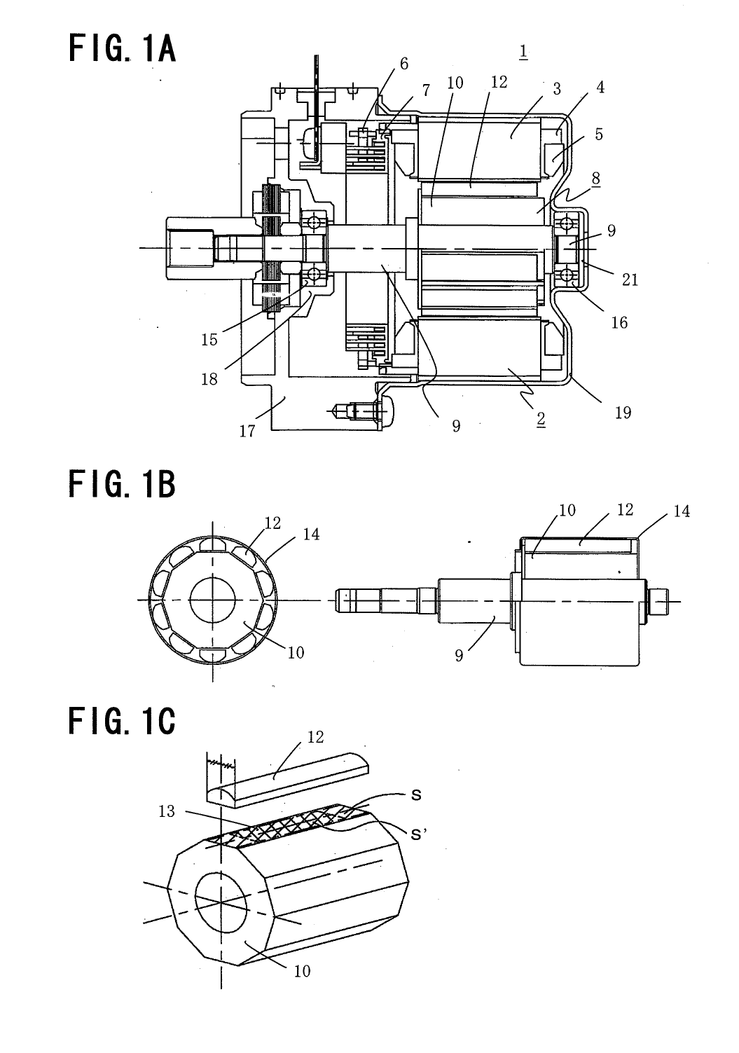

FIGS. 1A to 1C show a rotor of a rotary electric machine of Preferred Embodiment 1 of the present invention; FIG. 1A is a sectional view showing an example applicable to a motor for an electric power steering apparatus; FIG. 1B is a detail view of a rotor structure shown in FIG. 1A; and FIG. 1C is a view showing a bonded state between each of segment shaped magnets and a rotor core. In FIGS. 1A, 1B, and 1C, a rotary electric machine 1 is a permanent magnet rotary electric machine, and three phase stator windings 5 are wound via a resin-made insulator 4 on a stator core 3 formed by laminating magnetic steel sheets. Respective phase windings are connected in star or delta by winding terminals 6 placed in a resin-made terminal holder 7. The stator core 3 is fixed to an iron frame 19 by press-fitting and the like to constitute a stator 2 of the rotary electric machine 1. The frame 19 has a bottom face at one end portion thereof; and on the central portion of the bottom, a bare box portion 21 which places rear bearings 16 that support the one end of a rotor 8. The other end portion of the frame 19 is opened; a spigot joint part which is for fitting to an opening portion of the frame 19 is formed on a bracket 17; and a bare box portion 18 which places front bearings 15 that support the other end of the rotor 8 is formed on the central portion. The rear bearings 16 and the front bearings 15 are mounted at both ends of a rotational shaft 9 of the rotor 8, and the rotational shaft 9 is rotatably supported.

A plurality of segment shaped magnets 12 each having an arbitrary gap between poles are arranged and fixed by an adhesive 13 on an outer circumference face of a rotor core 10 which is fixed to the rotational shaft 9 of the rotor 8 by press-fitting and the like, and an outer circumference portion of the segment shaped magnets 12 are covered by a nonmagnetic ring 14.

A bonding portion S′ of each of the segment shaped magnets 12 is provided in axial symmetry with respect to the axial center of the rotor 8 and has a bonding area equal to or larger than a half of a contact area S between each of the segment shaped magnets 12 and the rotor core 10; and the ring 14 biases the segment shaped magnets 12 to the radial direction side of the rotor core 10.

According to the thus configured rotor of the rotary electric machine of Preferred Embodiment 1, the bonding portion S′ between the rotor core 10 and each of the segment shaped magnets 12 is bonded so as to be in axial symmetry with respect to the axial center of the rotor 8; and therefore, a large moment is not exerted on the segment shaped magnets 12 due to unbalance of bonding strength in the case of magnetization, and a fracture of the segment shaped magnets 12 and peel-off from the rotor core 10 can be prevented.

Further, the bonding area S′ equal to or larger than a half of the contact area S between each of the segment shaped magnets 12 and the rotor core 10 is ensured; and accordingly, the axial central portion serves as a support portion and a large moment is not applied to axial end portions of the segment shaped magnets 12, and a fracture of the segment shaped magnets 12 and peel-off from the rotor core 10 can be prevented.

In addition, since the segment shaped magnets 12 are biased to the rotor core 10 side by the ring 14, the amount of radial displacement can be further suppressed; and therefore, the occurrence of the moment can be suppressed.

Further, hardening of the adhesive 13 can be performed in a state where a biasing force is applied to the segment shaped magnets 12 by the ring 14; and therefore, the segment shaped magnets 12 are not moved during hardening of the adhesive 13, and stable bonding positions and bonding strength can be ensured.

### Preferred Embodiment 2

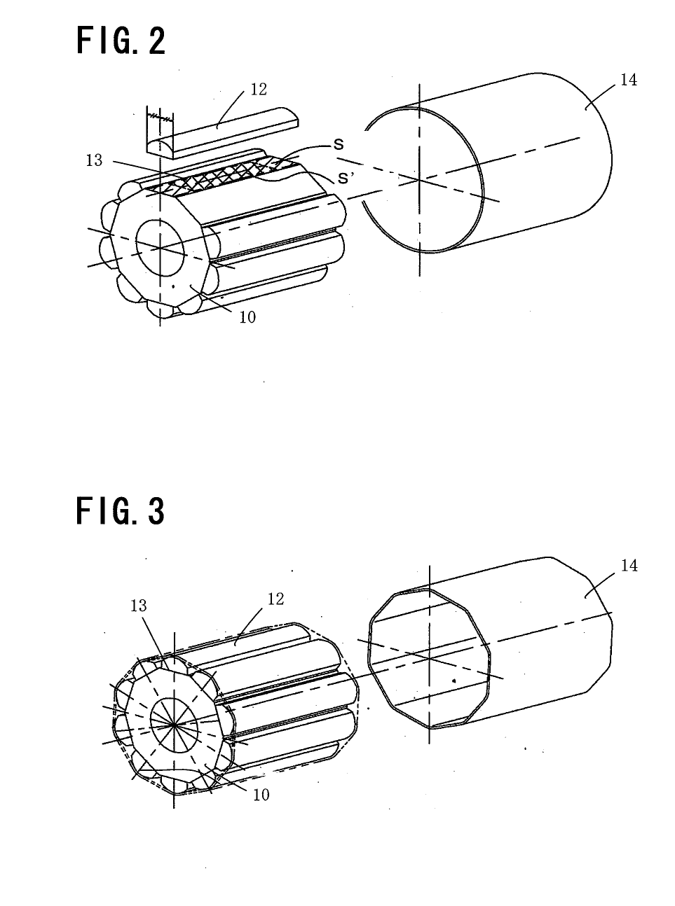

FIG. 2 is a detail view of a rotor structure of Preferred Embodiment 2 of the present invention, and is a view showing a relationship between a circumscribed circle diameter of an outer circumference of respective magnets and a ring inner diameter of a rotor.

That is, in the Preferred Embodiment 2, an inner diameter ΦDri of a ring 14 is set smaller than a circumscribed circle diameter ΦDm of an outer circumference of respective segment shaped magnets 12 bonded and fixed to an outer circumference face of a rotor core 10, and the segment shaped magnets 12 are biased to the radial direction side of the rotor core 10 in a state with an appropriate exposed thread.

According to the thus configured rotor of the rotary electric machine of Preferred Embodiment 2, a pull force is produced in a circumferential direction on the ring 14; however, by such an elastic force and an elastic force of an adhesive 13 intervened between each of the segment shaped magnets 12 and the rotor core 10, the segment shaped magnets 12 are supported with elasticity; and therefore, there can be suppressed the occurrence of large stress against an external force applied to the segment shaped magnets 12 in the case of magnetization and during product operation.

In addition, a stable biasing force can be controlled by the circumscribed circle diameter of the outer circumference of the segment shaped magnets 12 and dimensional control of the inner diameter of the ring 14; and therefore, workability is easy.

### Preferred Embodiment 3

FIG. 3 is a detail view of a rotor structure of Preferred Embodiment 3 of the present invention, and is a view showing a shape of a ring attached to an outer diameter of rotor magnets.

That is, in Preferred Embodiment 3, a ring 14 is formed in a polygon shape along an outer circumference shape of respective segment shaped magnets 12.

According to the thus configured rotor of the rotary electric machine of Preferred Embodiment 3, since the shape of the ring 14 is a polygon shape along the outer circumference face of the respective segment shaped magnets 12, a circumferential biasing force can also be applied in addition to a radial biasing force. Therefore, there can be suppressed the occurrence of large stress against an external force applied to the segment shaped magnets 12 in the case of magnetization and during product operation; further, the segment shaped magnets 12 do not move in a circumferential direction during hardening of an adhesive 13; and stable bonding positions and bonding strength can be ensured.

### Preferred Embodiment 4

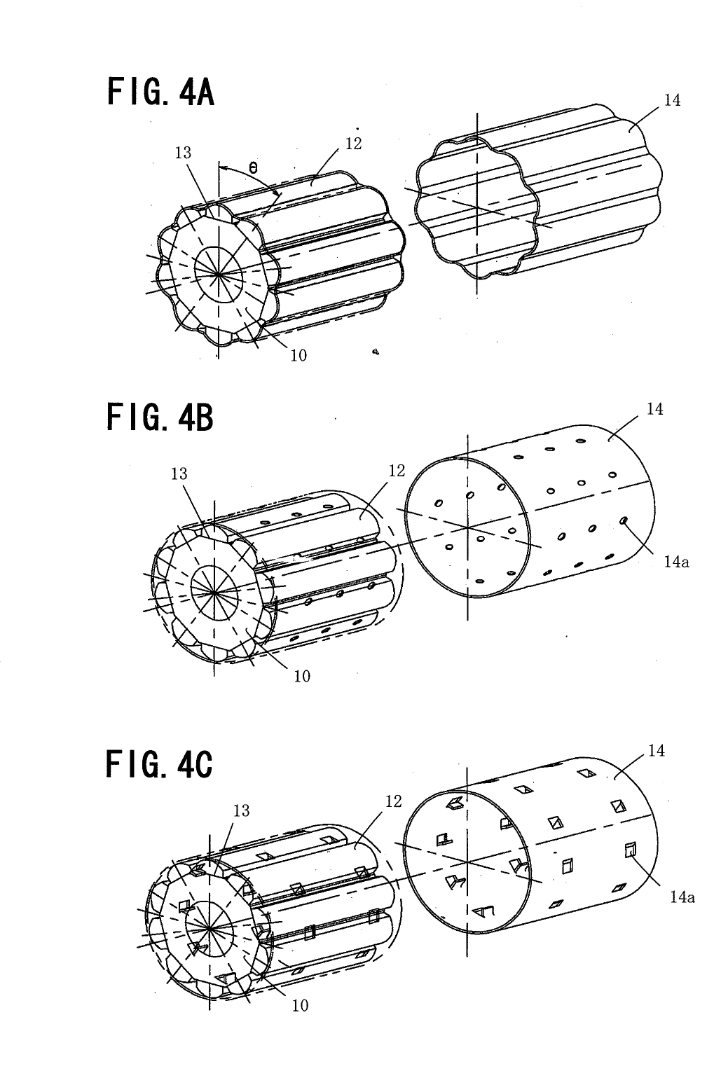

FIGS. 4A to 4C show a rotor of a rotary electric machine of Preferred Embodiment 4 of the present invention, and FIG. 4A is a detail view of a rotor structure showing an example of a shape of a ring attached to an outer diameter of rotor magnets.

In FIG. 4A, a ring 14 is a waveform shape along an outer circumference shape of respective segment shaped magnets 12, and the numbers thereof is formed at a pitch equal to the numbers of magnet poles, that is, θ=360°/n for the number of magnet poles n.

Incidentally, as other shape of a ring 14, as shown in FIG. 4B, a plurality of convex portions 14a are protruded to the inner circumferential side of the ring 14 toward a radial direction; and accordingly, positioning may be performed in a circumferential direction so that the segment shaped magnets 12 are arranged at equal pitch.

In addition, as further other shape of a ring 14, as shown in FIG. 4C, a part of the ring 14 is cut and bent to a ring internal diameter direction to protrude a plurality of convex portions 14a; and accordingly, positioning may be performed in a circumferential direction so that the segment shaped magnets 12 are arranged at equal pitch.

According to the thus configured rotor of the rotary electric machine of Preferred Embodiment 4, since the segment shaped magnets 12 are positioned and fixed at equal pitch by the shape of the ring 14, a retention force to the respective segment shaped magnets 12 is equalized; it is easy to perform position control at predetermined positions; an adhesive 13 is also easy to be evenly extended; and stable bonding strength can be ensured.

### Preferred Embodiment 5

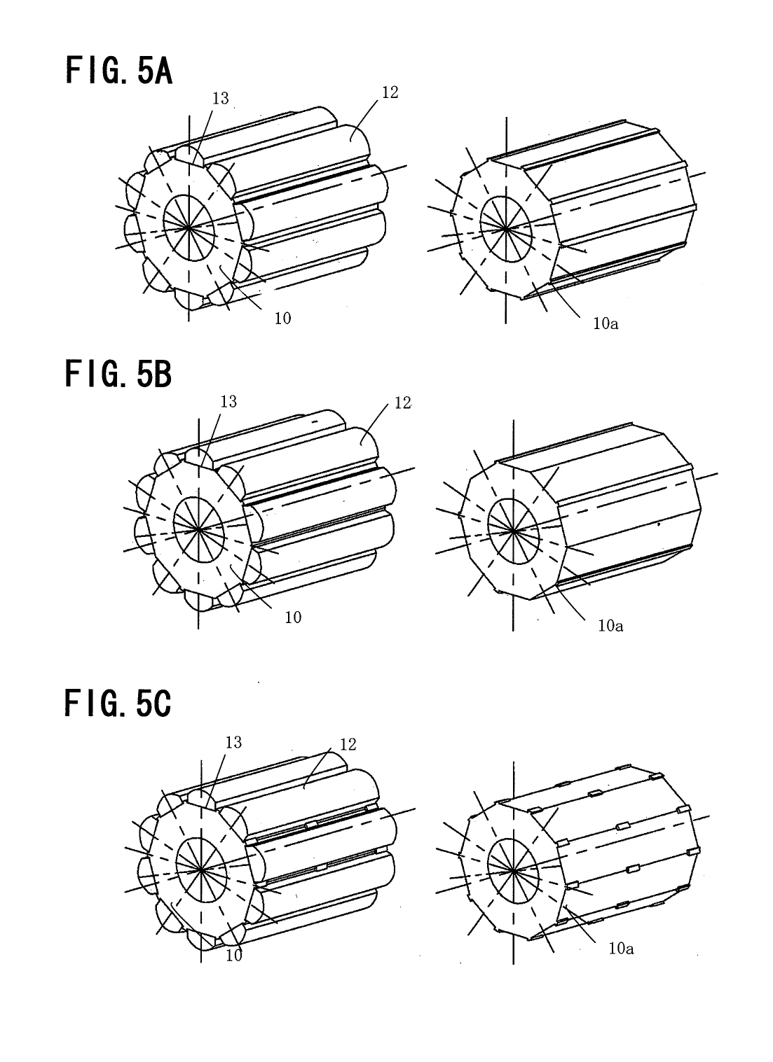

FIGS. 5A to 5C show a rotor of a rotary electric machine of a preferred embodiment of the present invention 5, and FIG. 5A is a detail view of a rotor structure showing an example of a side shape of a rotor core to which rotor magnets are stuck.

In FIG. 5A, convex portions 10a which perform circumferential positioning are provided on an outer circumference of a rotor core 10 of a rotor 8 at positions of the sides where segment shaped magnets 12 are stuck.

Incidentally, in FIG. 5A, the positioning convex portions 10a are provided on both sides of the sides where the segment shaped magnets 12 are stuck; however, if circumferential positioning can be performed, the positioning convex portions 10a may be provided only on one side as shown in FIG. 5B. In addition, the convex portions 10a need not to be provided on all sides in an axial direction of the rotor core 10; and the positioning convex portions 10a may be intermittently provided as shown in FIG. 5C.

According to the thus configured rotor of the rotary electric machine of Preferred Embodiment 5, since a circumferential biasing force can be surely applied by the rotor core 10, there can be suppressed the occurrence of large stress against an external force applied to the segment shaped magnets 12 in the case of magnetization and during product operation; further, the segment shaped magnets 12 do not move in a circumferential direction during hardening of an adhesive 13; and stable bonding positions and bonding strength can be ensured.

### Preferred Embodiment 6

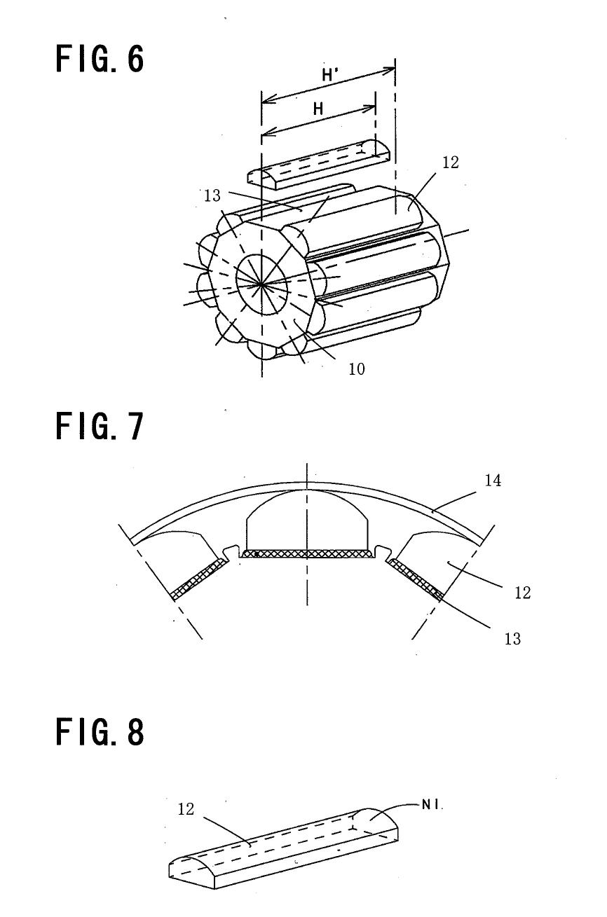

FIG. 6 is one showing a rotor of a rotary electric machine of Preferred Embodiment 6 of the present invention, and is a detail view of a rotor structure showing a relationship between the axial lengths of a rotor core and each of magnets of the rotor.

In FIG. 6, a relationship between the rotational axial length H of a magnet sticking face of a rotor core 10 and the rotational axial length H′ of a sticking face of segment shaped magnets 12 is consistently set to H>H′.

According to the thus configured rotor of the rotary electric machine of Preferred Embodiment 6 of the present invention, the rotational axial length of the segment shaped magnets 12 is set to be shorter than the rotational axial length of the magnet sticking face of the rotor core 10; and accordingly, there can be suppressed the occurrence of large stress against a circumferential external force applied to the segment shaped magnets 12 in the case of magnetization and during product operation.

In addition, in the case where an adhesive 13 is expected to apply to both end portions of the segment shaped magnets 12, the rotational axial length of the segment shaped magnets 12 is shorter than the rotational axial length of the rotor core 10; and therefore, the adhesive 13 can be surely and stably applied and fixed between the rotor core 10 and each of the segment shaped magnets 12.

### Preferred Embodiment 7

FIG. 7 is one showing a rotor of a rotary electric machine of Preferred Embodiment 7 of the present invention, and is a detail drawing of a bonding portion showing a state of an adhesive formed between a rotor core and each of magnets of a rotor.

In FIG. 7, the adhesive 13 used for fixing segment shaped magnets 12 and the rotor core is made of silicon resin.

According to the thus configured rotor of the rotary electric machine of Preferred Embodiment 7 of the present invention, silicon resin is used as the adhesive 13; and accordingly, it excels in heat resistance and the segment shaped magnets 12 can be held to a rotor core 10 in a state with an adequate elastic force.

In addition, even in the case where magnets whose linear expansion coefficient is largely different from that of the rotor core 10 and a ring 14, for example, even in the case where Nd—Fe group rare earth magnets and the like are bonded, the adhesive 13 itself has large elasticity; and therefore, stress produced in a bonding portion due to a change in temperature is alleviated and consequently a crack or deficiency in the magnets can be prevented.

### Preferred Embodiment 8

FIG. 8 is one showing Preferred Embodiment 8 of the present invention, and is a view showing surface finishing of rotor magnets.

That is, as shown in FIG. 8, Preferred Embodiment 8 of the present invention is one to which nickel plated finishing is applied to a surface of the segment shaped magnets 12 shown in FIG. 7.

According to the thus configured rotor of the rotary electric machine of Preferred Embodiment 8, rustproof function is maintained and stable plating is obtained by applying nickel plated finishing to the magnet surface; and therefore, in the case of using silicon group adhesive, a foaming phenomenon of a bonding layer, which is one of the causes of deterioration in bonding strength, can be suppressed and stable bonding strength can be ensured.

### Preferred Embodiment 9

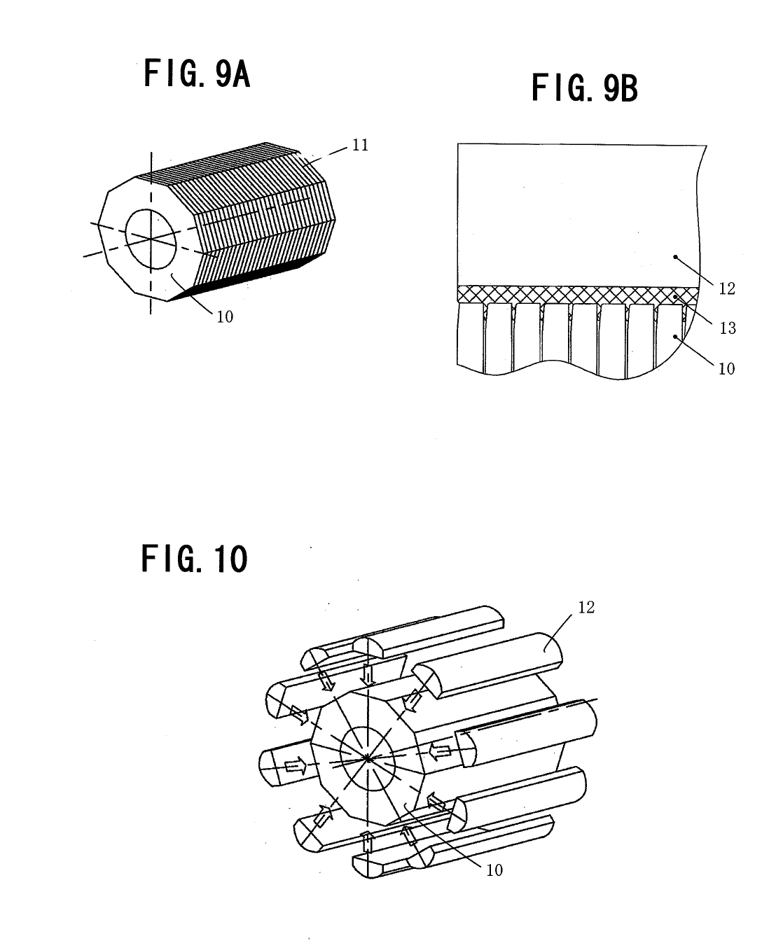

FIGS. 9A and 9B show a rotor of a rotary electric machine of Preferred Embodiment 9 of the present invention, and FIG. 9A is a detail view showing a rotor core structure of the rotor.

In FIG. 9A, a rotor core 10 is configured by laminating a plurality of steel sheets 11.

According to the thus configured rotor of the rotary electric machine of Preferred Embodiment 9, gas produced from bonding layers during hardening of an adhesive 13 is easily discharged between the respective steel sheets 11. Therefore, a foaming phenomenon in the bonding layers, which is one of the causes of deterioration in bonding strength, can be suppressed and stable bonding strength can be ensured. In addition, the adhesive 13 is easily entered into gaps of the respective steel sheets 11 by a radial biasing force of the rotor core 10; and therefore, as shown in FIG. 9B, more stable bonding strength can be ensured by wedge effect.

### Preferred Embodiment 10

FIG. 10 is one showing a method of manufacturing a rotor of a rotary electric machine of Preferred Embodiment 10 of the present invention, and is a view for explaining a manufacturing method related to bonding of rotor magnets.

That is, in the method of manufacturing the rotor of Preferred Embodiment 10, as shown in FIG. 10, segment shaped magnets 12 are assembled and bonded to magnet sticking portions of a rotor core 10 from a radial direction of the rotor.

According to the above manufacturing method of Preferred Embodiment 10, the segment shaped magnets 12 are assembled and come into contact with the rotor core 10 from the radial direction; and accordingly, adhesive previously applied between the rotor core 10 and each of the segment shaped magnets 12 is extended in an original state and therefore the thicknesses of bonding layers easily become uniform and stable bonding strength can be ensured. In addition, if the segment shaped magnets 12 are assembled to the rotor core 10 while shifting from an axial direction of the rotor, the thickness of the bonding layer becomes uneven; however, such uneven thickness can be prevented by assembling and bonding from radial directions.

### Preferred Embodiment 11

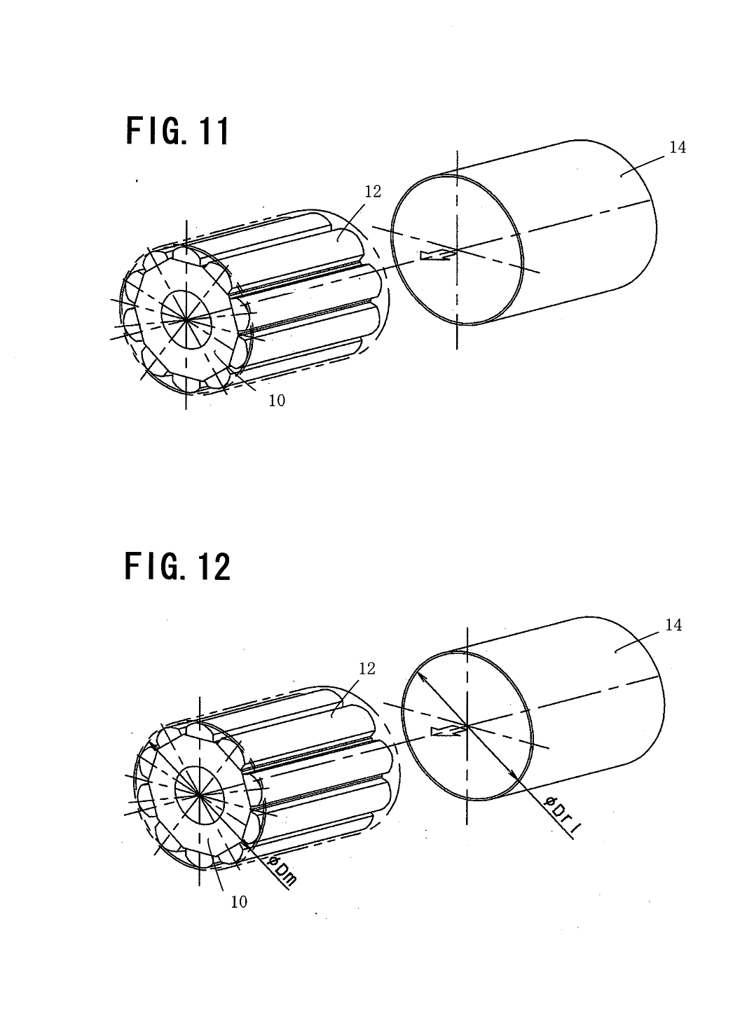

FIG. 11 is one showing a method of manufacturing a rotor of a rotary electric machine of Preferred Embodiment 11 of the present invention, and is a view for explaining a manufacturing method related to assembling of a rotor ring.

That is, in the method of manufacturing the rotor of Preferred Embodiment 11, as shown in FIG. 11, a ring 14 is press-fitted to a circumscribed circle diameter of an outer circumference of segment shaped magnets 12.

According to the above manufacturing method of Preferred Embodiment 11, a biasing force can be applied to the respective segment shaped magnets 12 by a simple method that is a press-fitting process. In addition, the ring 14 itself is press-fitted and is extended in a radial direction; and accordingly, the biasing force is applied to the segment shaped magnets 12 and therefore a dimensional variation in outer diameter of the rotor and a dimensional variation in inner diameter of the ring 14 can be absorbed.

### Preferred Embodiment 12

FIG. 12 is one showing a method of manufacturing a rotor of a rotary electric machine of Preferred Embodiment 12 of the present invention, and is a view for explaining other manufacturing method related to assembling of a rotor ring.

That is, in the method of manufacturing the rotor of Preferred Embodiment 12, as shown in FIG. 12, a ring 14 is shrink-fitted to an outer circumference portion of segment shaped magnets 12.

Incidentally, ΦDri is an inner diameter of the ring 14, ΦDm is a circumscribed circle diameter of an outer circumference of the segment shaped magnets 12, and a relationship therebetween is ΦDm>ΦDri during normal temperature and ΦDm<ΦDri during shrink-fitting.

According to the above manufacturing method of Preferred Embodiment 12, the shape of the ring 14 of pre-assembly can be formed in a simple circular tube and the ring 14 can be entered with a gap with respect to the outer circumference portion of the respective segment shaped magnets 12 during assembling; and therefore, deviation of the segment shaped magnets 12 can be suppressed and it becomes easy to manufacture.

In addition, a biasing force can be applied by thermal stress; and therefore, the biasing force can be effectively applied to the segment shaped magnets 12.

Various modifications and alternations of this invention will be apparent to those skilled in the art without departing from the scope and spirit of this invention, and it should be understood that this is not limited to the illustrative embodiments set forth herein.

What is claimed is:

1. A rotor of a rotary electric machine, the rotary electric machine including:
a rotor core fitted to an outer circumference of a rotational shaft;
a rotor formed by arranging and bonding a plurality of segment shaped magnets each having an arbitrary gap between poles on an outer circumference portion of the rotor core by adhesive;
a bracket rotatably supporting a rotational shaft of the rotor via bearings; and
a stator fixed to the bracket and having a stator core and stator windings, the rotor of the rotary electric machine comprising:
a bonding portion formed by the adhesive between each of the segment shaped magnets of the rotor and the outer circumference face of the rotor core, the bonding portion being provided in axial symmetry with respect to the rotor axial center and having a bonding area equal to or larger than a half of a contact area between each of the segment shaped magnets and the outer circumference face of the rotor core; and
a nonmagnetic ring fitted to an outer circumference portion of the segment shaped magnets, the segment shaped magnets being fixed by being biased by the ring to the rotor core side.

2. The rotor of the rotary electric machine according to claim 1,
wherein the segment shaped magnets are biased by the ring in a radial direction of the rotor core with an exposed thread.

3. The rotor of the rotary electric machine according to claim 2,
wherein the ring is formed in a polygon shape along an outer shape of the respective segment shaped magnets.

4. The rotor of the rotary electric machine according to claim 1,
wherein the segment shaped magnets are arranged at equal pitch in a circumferential direction of the rotor core.

5. The rotor of the rotary electric machine according to claim 1,
wherein the rotor core is provided with circumferential positioning means at a position of at least one circumferential side of a face to which each of the segment shaped magnets is stuck.

6. The rotor of the rotary electric machine according to claim 1,
wherein the segment shaped magnets are shorter in axial length of the magnets than in rotational axial length of magnet sticking portions of the rotor core.

7. The rotor of the rotary electric machine according to claim 1,
wherein the adhesive which fixes the rotor core and the segment shaped magnets is made of silicon resin.

8. The rotor of the rotary electric machine according to claim 7,
wherein the segment shaped magnets have their surfaces where nickel plating is applied.

9. The rotor of the rotary electric machine according to claim 1,
wherein the rotor core is composed of a plurality of lamination sheets.

10. A method of manufacturing a rotor of a rotary electric machine as set forth in claim 1, the method of manufacturing the rotor of the rotary electric machine, comprising the step of:
bonding the segment shaped magnets from a radial direction of the rotor core.

11. A method of manufacturing a rotor of a rotary electric machine as set forth in claim 1, the method of manufacturing the rotor of the rotary electric machine, comprising the step of:
press-fitting the ring to the outer circumference portion of the segment shaped magnets.

12. A method of manufacturing a rotor of a rotary electric machine as set forth in claim 1, the method of manufacturing the rotor of the rotary electric machine, comprising the step of:
shrink-fitting the ring to the outer circumference portion of the segment shaped magnets.
